(19) United States
(12) Patent Application Publication
(10) Pub. No.: US 2026/0202128 A1
(43) Pub. Date: Jul. 16, 2026

(54) LASER DRYING DEVICE

(71) Applicant: TOYOTA JIDOSHA KABUSHIKI KAISHA, Aichi-ken (JP)

(72) Inventors: Tadashi TERANISHI, Toyota-shi (JP); Masato ONO, Nagoya-shi (JP); Yusuke OISHI, Toyota-shi (JP); Tomofumi HIRUKAWA, Miyoshi-shi (JP); Yosuke SHIMURA, Nagakute-shi (JP); Hiroshi KAWASAKI, Toyota-shi (JP); Katsuhisa TSUZUKI, Toyota-shi (JP); Takashi IZU, Kashiba-shi (JP)

(21) Appl. No.: 19/444,196

(22) Filed: Jan. 9, 2026

(30) Foreign Application Priority Data
Jan. 14, 2025 (JP) 2025-004975

(51) Int. Cl. F26B 3/28; H01M 4/04

(52) U.S. Cl. CPC F26B 3/283; H01M 4/0471

(57) ABSTRACT

A laser drying device for drying an electrode mixture layer, wherein the laser drying device includes a furnace body, a rectifier plate, a laser light source, and hot air supply equipment, the rectifier plate is arranged in an interior of the furnace body, is arranged between the electrode mixture layer and the laser light source, and is configured so as to transmit laser light, the laser light source irradiates the electrode mixture layer with laser light via the rectifier plate, and the hot air supply equipment supplies hot air between the rectifier plate and the electrode mixture layer.

### FIELD

The present disclosure relates to a laser drying device.

### BACKGROUND

As a method for drying an electrode mixture layer applied upon a current collector layer, laser drying is known. Laser drying consumes less energy than hot air drying and has a lower environmental impact. Various proposals for improving the drying efficiency of laser drying have been made.

Patent Literature 1 discloses a method for the production of an electrode assembly, comprising a conveying step of conveying an electrode assembly to which at least one electrode material has been applied by means of a conveyor, and a drying step of drying the electrode material while conveying the electrode assembly by means of the conveyor, wherein the drying step includes an irradiation step of irradiating the electrode material with a laser while the electrode assembly is conveyed to at least one first position in the conveyance direction of the conveyor to dry the electrode material, and a recovery step of recovering vapor generated by the laser irradiation of the electrode material by a vapor recovery unit provided in at least one second position adjacent to the first position in the conveyance direction. Patent Literature 1 describes that, according to the disclosure of Patent Literature 1, a reduction in drying efficiency when the electrode material is dried by means of a laser can be suppressed.

Patent Literature 2 discloses a method for the production of an electrode sheet, comprising a preparation step of preparing a coated sheet having a coated portion to which an electrode material has been applied on a first surface of a current collecting sheet having a longitudinal direction in a first direction, and a drying step of conveying the coated sheet in the first direction while irradiating the coated portion with laser light from a plurality of laser heads arranged in the first direction to dry the coated portion, whereby an electrode sheet is obtained, wherein the drying step comprises supplying hot air at a temperature of 50° C. or higher and 140° C. or lower and at an air speed of 5 m/s or higher to the laser-irradiated portions of the conveyed coated sheet which have been irradiated with laser light from each laser head until a subsequent laser irradiation. Patent Literature 2 describes that, according to the disclosure of Patent Literature 2, an electrode sheet in which an increase in drying time is suppressed while a decrease in peel strength between the electrode layer and the current collecting sheet is suppressed can be produced.

When drying an electrode mixture layer by supplying hot air thereto, arranging a rectifier plate within the drying device has been proposed.

Patent Literature 3 discloses a drying device comprising a conveyance path including a plurality of conveyor rollers in an interior thereof, the device further comprising a plurality of hot air supply parts which face the conveyance path and which are arranged along the conveyance path, for supplying hot air to the conveyance path, and rectifier plates which are arranged between adjacent hot air supply parts for guiding the hot air along the conveyance direction, wherein the rectifier plates include hot air exhaust parts for exhausting hot air, and the hot air exhaust parts are shaped such that, when the direction perpendicular to the conveyance direction of the conveyance path is defined as the width direction, the length of each hot air exhaust part in the conveyance direction at the width direction center is longer than the length of the hot air exhaust part in the conveyance direction at the width direction ends. Patent Literature 3 describes that, according to the disclosure of Patent Literature 3, stagnation due to hot air interference can be suppressed, whereby drying unevenness can be suppressed.

### CITATION LIST

### Patent Literature

[PTL 1] Japanese Unexamined Patent Publication (Kokai) No. 2023-169591
[PTL 2] Japanese Unexamined Patent Publication (Kokai) No. 2024-020819
[PTL 3] Japanese Unexamined Patent Publication (Kokai) No. 2023-014755

### SUMMARY

### Technical Problem

When using a laser light source to dry an electrode mixture layer, in order to increase the laser irradiation area of the electrode mixture layer, it is necessary to increase the distance between the laser light source and the workpiece. In this case, it is necessary to increase the size of the furnace body.

When performing laser drying, drying efficiency can be increased by supplying hot air to the electrode mixture layer inside the furnace body. However, when the size of the furnace body is increased as described above, the hot air diffuses, and it is difficult for hot air to be supplied to the electrode mixture layer, whereby the expected drying efficiency may not be obtained.

Thus, an object of the present disclosure is to provide a highly efficient laser drying device.

### Solution to Problem

The present disclosure achieves the object described above by the following means.

### <Aspect 1>

A laser drying device for drying an electrode mixture layer, wherein
the laser drying device comprises a furnace body, a rectifier plate, a laser light source, and hot air supply equipment,
the rectifier plate is arranged in an interior of the furnace body, is arranged between the electrode mixture layer and the laser light source, and is configured so as to transmit laser light,
the laser light source irradiates the electrode mixture layer with laser light via the rectifier plate, and
the hot air supply equipment supplies hot air between the rectifier plate and the electrode mixture layer.

### <Aspect 2>

The device according to Aspect 1, wherein the furnace body comprises a laser-transmitting protective plate, and
the laser light source irradiates the electrode mixture layer with laser light via the protective plate and then the rectifier plate.

### <Aspect 3>

The device according to Aspect 1 or 2, wherein when a distance between the laser light source and the electrode mixture layer is defined as x and a distance between the rectifier plate and the electrode mixture layer is defined as y, the following relationship is satisfied:

$$x / y \leq 0.15 .$$

### <Aspect 4>

The device according to any one of Aspects 1 to 3, wherein a laser light transmittance of the rectifier plate with respect to laser light emitted from the laser light source is 95.0% or more.

### <Aspect 5>

A method for the production of an electrode laminate using the device according to any one of Aspects 1 to 4, the method comprising the steps of:

irradiating an electrode mixture layer applied to a current collector layer with laser light, and supplying hot air to an interior of the furnace body.

### Advantageous Effects of Invention

According to the present disclosure, there can be provided a highly efficient laser drying device.

### BRIEF DESCRIPTION OF DRAWINGS

FIG. 1 is a schematic view detailing a laser drying device of the present disclosure.

FIG. 2 is a schematic view detailing the laser drying device of the present disclosure.

FIG. 3 is a schematic view detailing the laser drying device of the present disclosure.

### DESCRIPTION OF EMBODIMENTS

### <<Laser Drying Device>>

A laser drying device for drying an electrode mixture layer, wherein
the laser drying device comprises a furnace body, a rectifier plate, a laser light source, and hot air supply equipment,
the rectifier plate is arranged in an interior of the furnace body, is arranged between the electrode mixture layer and the laser light source, and is configured so as to transmit laser light,
the laser light source irradiates the electrode mixture layer with laser light via the rectifier plate, and
the hot air supply equipment supplies hot air between the rectifier plate and the electrode mixture layer.

According to the present disclosure, there can be provided a highly efficient laser drying device.

The present inventors have investigated increasing drying efficiency by supplying hot air to the interior of the furnace body using hot air supply equipment when laser drying the electrode mixture layer. However, when the distance between the laser light source and the electrode mixture layer is increased in order to increase the laser irradiation area of the electrode mixture layer, the hot air diffuses, and it is difficult for hot air to be supplied to the electrode mixture layer.

The present inventors have found that the above problem can be solved by arranging a rectifier plate between the electrode mixture layer in the interior of the furnace body and the laser light source, and supplying hot air between the rectifier plate and the electrode mixture layer. By arranging a rectifier plate, the flow path of the hot air is regulated, whereby hot air can appropriately be supplied to the electrode mixture layer.

Furthermore, though laser light is supplied to the electrode mixture layer via the rectifier plate, since the rectifier plate has high transparency with respect to the laser light, the laser light is efficiently supplied to the electrode mixture layer.

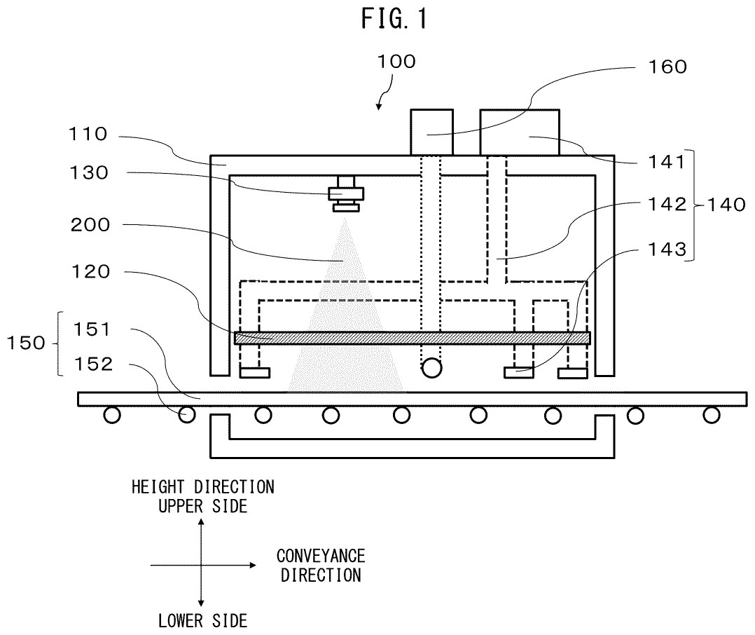

Specifically, as shown in, for example, FIG. 1, a laser drying device 100 comprises a furnace body 110, a rectifier plate 120, a laser light source 130, and hot air supply equipment 140. The laser drying device 100 further comprises conveying equipment 150 for moving the electrode mixture layer arranged on a conveyor belt 151 at a constant speed in the conveyance direction by rotating conveyor rollers 152. Thus, the electrode mixture layer can be conveyed from outside of the furnace body 110 to the interior of the furnace body 110, and the electrode mixture layer can be conveyed from the interior of the furnace body 110 to outside of the furnace body 110.

In the interior of the furnace body 110, a rectifier plate 120 is arranged between the laser light source 130 and the conveyor belt 151. The electrode mixture layer on the conveyor belt 151, which has been conveyed into the interior of the furnace body 110 by the conveying equipment 150, is irradiated with laser light 200 from the laser light source 130 via the rectifier plate 120.

The hot air supply equipment 140 is constituted by a hot air generator 141, an air supply duct 142, and an air supply nozzle 143. The hot air supply equipment 140 supplies hot air generated by the hot air generator 141 to the interior of the furnace body 110 via the air supply duct 142 and the air supply nozzle 143. The hot air is supplied between the rectifier plate 120 and the electrode mixture layer. The hot air is also supplied in the conveyance direction and in the direction opposite to the conveyance direction. By supplying hot air, steam generated near the surface of the electrode mixture layer due to the laser irradiation is removed by the hot air and is then exhausted outside the furnace body 110 by exhaust equipment 160. Further, by arranging the rectifier plate 120, the flow path of the hot air is regulated, thereby improving drying efficiency of the electrode mixture layer.

The embodiments of the present disclosure will be described in detail below. Note that the present disclosure is not limited to the following embodiments, and various modifications can be made within the scope of the spirit of the present disclosure.

The laser drying device of the present disclosure is a laser drying device for drying an electrode mixture layer.

The phrase “electrode mixture” as used herein refers to a composition that can constitute an electrode active material layer either as-is or by further containing other components. Further, the phrase “electrode mixture layer” refers to a layer which contains a dispersion medium in addition to the “electrode mixture” and which can be applied and dried to form an electrode active material layer.

The laser drying device of the present disclosure comprises a furnace body, a rectifier plate, a laser light source, and hot air supply equipment. The laser drying device may further comprise conveying equipment and exhaust equipment.

The rectifier plate is arranged in the interior of the furnace body, and is arranged between the electrode mixture layer and the laser light source. By installing the rectifier plate, the space where hot air is supplied can be narrowed, whereby the provision of hot air to the electrode mixture layer is facilitated.

When the distance between the laser light source and the electrode mixture layer is defined as x and the distance between the rectifier plate and the electrode mixture layer is defined as y, the laser drying device of the present disclosure may satisfy y/x≤0.15, 0.14, 0.13, 0.12, 0.10, 0.08, or 0.05. By satisfying this relationship, the rectification effect of the hot air due to arrangement of the rectifier plate is enhanced, whereby drying efficiency is increased. Furthermore, y/x≥0.01, 0.02, 0.03, or 0.04 may also be satisfied.

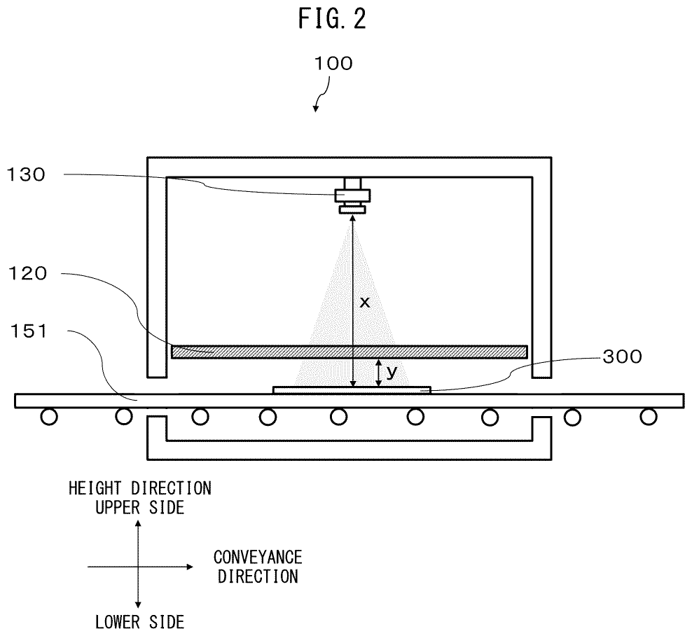

Specifically, as shown in, for example, FIG. 2, an electrode mixture layer 300 is arranged on the conveyor belt 151 and is irradiated with laser light. The distance x described above is the shortest distance from the laser light irradiation portion of the laser light source 130 to the electrode mixture layer 300 in the height direction. Furthermore, the distance y described above is the shortest distance from the rectifier plate 120 to the electrode mixture layer 300 in the height direction.

The distance x between the laser light source and the electrode mixture layer is not particularly limited, and may be determined appropriately taking into consideration the irradiation area of the laser light, etc. The distance x may be, for example, 300 mm or more, 500 mm or more, 1000 mm or more, 1500 mm or more, or 2000 mm or more, and may be 5000 mm or less, 4000 mm or less, or 3000 mm or less. The laser light source may be arranged in the interior of the furnace body, or may be arranged outside the furnace body.

The distance y between the rectifier plate and the electrode mixture layer is not particularly limited, and may be determined appropriately taking into consideration y/x, the thickness of the electrode mixture layer, etc. The distance y may be, for example, 5 mm or more, 10 mm or more, 30 mm or more, 50 mm or more, or 100 mm or more, and may be 750 mm or less, 500 mm or less, 400 mm or less, or 300 mm or less.

The energy density of the laser light emitted from the laser light source onto the electrode mixture layer in the drying furnace is not particularly limited, and may be, for example, 0.1 W/cm² or more, 0.5 W/cm² or more, 1.0 W/cm² or more, 2.0 W/cm² or more, or 3.0 W/cm² or more, and may be 20.0 W/cm² or less, 10.0 W/cm² or less, 7.0 W/cm² or less, or 4.0 W/cm² or less.

### <Rectifier Plate>

The rectifier plate is configured so as to transmit laser light. Since the rectifier plate transmits laser light, the laser light emitted from the laser light source can efficiently irradiate the electrode mixture layer.

The laser light transmittance of the rectifier plate with respect to the laser light emitted from the laser light source may be 95.0% or more. Furthermore, the transmittance may be 96.0% or more, 97.0% or more, 98.0% or more, 99.0% or more, 99.5% or more, or 99.8% or more, and may be 100.0% or less or 99.9% or less.

The transmittance of laser light is the transmittance at a single wavelength when the laser light is of a single wavelength, and is the transmittance at the wavelength having the highest intensity when the laser light is of multiple wavelengths. The transmittance of laser light can be measured by spectrophotometry using a UV-Vis-NIR spectrophotometer (SolidSpec-3700 DUV, manufactured by Shimadzu Corporation).

The material of the rectifier plate is not particularly limited as long as it is laser-transmitting, and materials which can withstand temperatures equal to or higher than the temperature of the hot air may be adopted. Examples of the material of the rectifier plate include glass, acrylic (PMMA), polycarbonate (PC), and polyetheretherketone (PEEK).

The glass may be, for example, quartz glass, soda-lime glass, lead glass, borosilicate glass, or alkali glass.

The dimensions of the rectifier plate are not particularly limited, any dimensions which facilitate the provision of hot air to the electrode mixture layer may be adopted, and the dimensions may be appropriately determined in accordance with the dimensions of the furnace body, the position of the hot air supply nozzle, etc. For example, the length of the rectifier plate 120 in the conveyance direction of FIG. 1, relative to the width direction length of the furnace body, may be 30% or more, 50% or more, 70% or more, or 90% or more, and may be 100% or less or 95% or less. Furthermore, the length of the rectifier plate 120 in the direction perpendicular to the conveyance direction and the height direction (width direction), relative to the width direction length of the furnace body, may be 30% or more, 50% or more, 70% or more, or 90% or more, and may be 100% or less or 95% or less.

The thickness of the rectifier plate is not particularly limited and may be appropriately determined in accordance with the material of the rectifier plate, etc. The thickness of the rectifier plate may be, for example, 1 mm or more, 3 mm or more, 5 mm or more, 7 mm or more, or 10 mm or more, and may be 30 mm or less, 25 mm or less, 20 mm or less, or 15 mm or less.

The rectifier plate may be inclined so as to approach the electrode mixture layer from the inlet to the outlet of the furnace body, or may be inclined so as to approach the electrode mixture layer from the outlet to the inlet of the furnace body.

The rectifier plate may be constituted by a single plate, or may be constituted by joining a plurality of plate pieces.

The method for retaining the rectifier plate is not particularly limited, and may be, for example, suspension, support, etc.

### <Furnace Body>

The furnace body may comprise a laser-transmitting protective plate. In this case, at least a part of the exterior of the furnace body may be the laser-transmitting protective plate. By providing the laser-transmitting protective plate, even if the laser light source is arranged outside the furnace body, the laser can irradiate the interior of the furnace body 110 via the laser-transmitting protective plate.

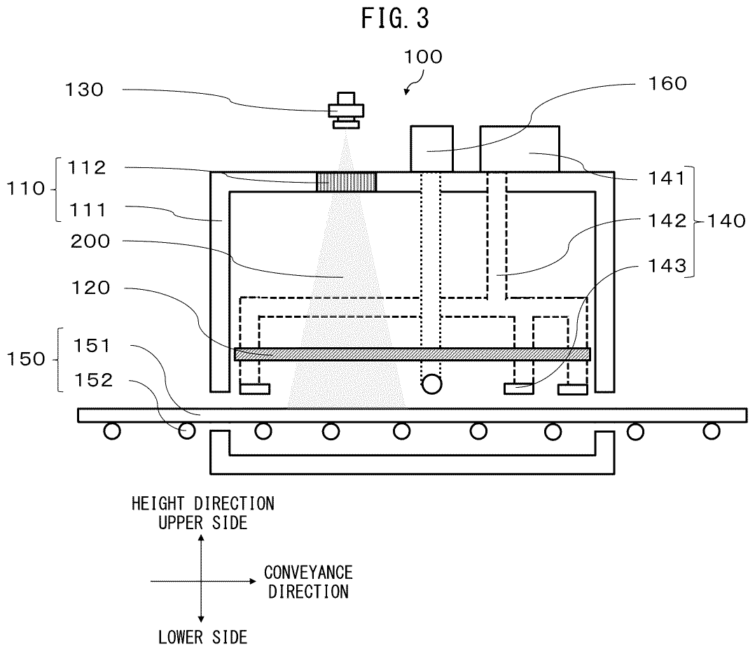

Specifically, as shown in, for example, FIG. 3, the furnace body 110 comprises an exterior base material 111 and a laser-transmitting protective plate 112, and the laser light source 130 is arranged outside the furnace body 110. Even if the interior of the furnace body 110 is hot, since the heat is not transferred to the laser light source, risk of failure of the laser light source can be reduced.

The arrangement position of the laser-transmitting protective plate may be a position where laser light generated from the laser light source arranged outside the furnace body can be efficiently transmitted to the interior of the furnace body via the laser-transmitting protective plate.

The material of the exterior base material of the furnace body is not particularly limited, and may be, for example, steel, stainless steel, aluminum, etc. The furnace body may be surface-treated by galvanization, powder coating, etc.

The dimensions of the furnace body are not particularly limited and may be determined appropriately taking into consideration the dimensions of the electrode mixture layer, etc. The furnace body may also have an opening for carrying in and out the electrode mixture layer using conveying equipment.

### (Laser-Transmitting Protective Plate)

The laser light transmittance of the laser-transmitting protective plate may be 95.0% or more, 96.0% or more, 97.0% or more, 98.0% or more, 99.0% or more, 99.5% or more, or 99.8% or more, and may be 100.0% or less or 99.9% or less.

The transmittance of laser light is the transmittance at a single wavelength when the laser light is of a single wavelength, and is the transmittance at the wavelength having the highest intensity when the laser light is of multiple wavelengths. The transmittance of laser light can be measured by spectrophotometry using a UV-Vis-NIR spectrophotometer (SolidSpec-3700 DUV, manufactured by Shimadzu Corporation).

The thermal conductivity of the laser-transmitting protective plate may be 1.50 W/(M·K) or less, 1.40 W/(M·K) or less, 1.38 W/(M·K) or less, 1.35 W/(M·K) or less, 1.30 W/(M·K) or less, 1.20 W/(M·K) or less, 1.10 W/(M·K) or less, or 1.00 W/(M·K) or less, and may be 0.10 W/(M·K) or more, 0.30 W/(M·K) or more, or 0.50 W/(M·K) or more. By reducing the thermal conductivity, the laser light source does not receive and is protected from the impact of the temperature in the furnace body interior.

The thermal conductivity can be measured by the heat flow meter method in accordance with ASTEM-E-1530.

The material of the laser-transmitting protective plate may be glass. Regarding the glass, refer to the foregoing descriptions regarding the rectifier plate.

The laser-transmitting protective plate may be double-glazed glass, which improves heat insulation performance. The double-glazed glass may be formed by sealing air, argon gas, krypton gas, etc., between a plurality of panes of glass.

The thickness of the laser-transmitting protective plate is not particularly limited, and may be appropriately determined in accordance with the material of the laser-transmitting protective plate, etc. The thickness of the laser-transmitting protective plate may be, for example, 1 mm or more, 3 mm or more, 5 mm or more, 7 mm or more, or 10 mm or more, and may be 30 mm or less, 25 mm or less, 20 mm or less, or 15 mm or less.

The dimensions of the laser-transmitting protective plate are not particularly limited, and may be any dimensions by which the laser light generated from the laser light source can thoroughly pass therethrough to the furnace body interior.

### <Laser Light Source>

The laser light source irradiates the electrode mixture layer via the rectifier plate. Since the rectifier plate has high laser transmittance, the light energy generated by the laser light source can be efficiently supplied to the electrode mixture layer. Furthermore, when the furnace body comprises the laser-transmitting protective plate, the laser light source can also irradiate the electrode mixture layer with laser light via the protective plate and the rectifier plate. As a result,
the electrode mixture layer can be irradiated with laser light even if the laser light source is arranged outside the furnace body.

The type of the laser light source is not particularly limited, and may be, for example, a Yb fiber laser, a YAG laser, or a carbon dioxide laser. The wavelength of the laser light may be 0.5 μm or more, 0.6 μm or more, 0.7 μm or more, 0.8 μm or more, or 0.9 μm or more, and may be 1.5 μm or less, 1.4 μm or less, 1.3 μm or less, 1.2 μm or less, or 1.1 μm or less.

The output of the laser light source is not particularly limited, and may be appropriately determined in accordance with the irradiation area of the laser light, the possible irradiation time of the laser light, etc. The output of the laser light source may be, for example, 0.1 kW or more, 1 kW or more, 5 KW or more, 10 KW or more, 15 kW or more, 20 kW or more, or 30 kW or more, and may be 100 KW or less, 70 kW or less, or 50 kW or less.

The number of laser light sources is not particularly limited, and may be appropriately determined in accordance with the irradiation area of the laser light, the possible irradiation time of the laser light, etc. The number of laser light sources may be, for example, 1 or more, 2 or more, 3 or more, 5 or more, or 10 or more, and may be 30 or less, or 20 or less.

The shape of the area of the electrode mixture layer irradiated with the laser light may be, for example, rectangular. The size of the area of irradiation is not particularly limited, and may be appropriately determined in accordance with the dimensions of the electrode mixture layer. The area of the area of irradiation is not particularly limited, and may be, for example, 100 cm² or more, 1000 cm² or more, 5000 cm² or more, or 10000 cm² or more, and may be 100000 cm² or less, 50000 cm² or less, or 30000 cm² or less.

### <Hot Air Supply Equipment>

The hot air supply equipment supplies hot air between the rectifier plate and the electrode mixture layer. By supplying hot air to the electrode mixture layer, steam can be removed from the surface of the electrode mixture layer, improving drying efficiency.

The temperature of the hot air supplied from the hot air supply equipment may be 100° C. or higher, 120° C. or higher, 150° C. or higher, 200° C. or higher, 250° C. or higher, or 300° C. or higher, and may be 500° C. or lower, 450° C. or lower, 400° C. or lower, or 350° C. or lower.

The hot air supply equipment is not particularly limited, and may be configured to supply air heated by, for example, gas combustion, oil combustion, electric heating, etc., to the electrode mixture layer by a blower fan through a blower duct and a blower nozzle. From the viewpoint of drying of the electrode mixture layer, it is preferable that the hot air have low humidity.

The supply direction of the hot air is not particularly limited, and may be opposite to the conveyance direction when, for example, the electrode mixture layer is conveyed through the interior of the furnace body. Furthermore, a plurality of blowing nozzles may be arranged, each having a different supply direction.

The air speed of the hot air is not particularly limited, and may be, for example, 5 m/s or more, 10 m/s or more, 15 m/s or more, or 20 m/s or more. A higher air speed increases drying efficiency of the electrode mixture layer. The air speed of the hot air may be 60 m/s or less, 50 m/s or less, 40 m/s or less, or 30 m/s or less.

### <Conveying Equipment>

The conveying equipment is not particularly limited, and may be, for example, a roller conveyor, a belt conveyor, etc. The electrode mixture layer may be arranged on, for example, a conveying path and introduced into the interior of the furnace body and conveyed to the outside of the furnace body.

The electrode mixture layer may be irradiated with laser light while being transported through the furnace body interior by the conveying equipment. In this case, the transport speed may be appropriately determined in consideration of the output of the laser light source, the amount of energy required to dry the electrode mixture layer, etc. The transport speed may be, for example, 0.1 m/s or more, 0.3 m/s or more, 0.5 m/s or more, or 1.0 m/s or more, or 3.0 m/s or less, 2.5 m/s or less, or 2.0 m/s or less.

The conveying equipment may be connected to other devices such as an electrode mixture layer application device and an electrode laminate winding device.

### <Exhaust Equipment>

The laser drying device may also comprise exhaust equipment. By providing exhaust equipment, steam generated from the electrode mixture layer can be recovered, thereby improving drying efficiency. The steam can be water vapor or other gases.

The exhaust equipment may be configured so as to, for example, suction in steam from an exhaust port by means of an exhaust fan and discharge the steam to the outside of the furnace body via an exhaust duct. The output of the exhaust fan and the dimensions of the exhaust port and exhaust duct may be appropriately determined in consideration of the amount of steam generated, etc.

From the viewpoint of improving drying efficiency, it is preferable that the exhaust port be arranged above the electrode mixture layer and in a position which does not interfere with laser irradiation. The distance between the exhaust port and the electrode mixture layer may be such that vapor can be suctioned. The number of exhaust ports is not particularly limited.

### <<Electrode Laminate Production Method>>

A method for the production of an electrode laminate using the laser drying device according to the present disclosure, the method comprising the steps of:

irradiating an electrode mixture layer applied to a current collector layer with laser light, and supplying hot air to an interior of the furnace body.

According to the present disclosure, there can be provided a method for the production of an electrode laminate with high drying efficiency.

The method of the present disclosure is a method for the production of an electrode laminate using the laser drying device of the present disclosure. Regarding the laser drying device, reference can be made to the foregoing description of the laser drying device.

The method of the present disclosure comprises irradiating the electrode mixture layer applied to a current collector layer with laser light. Regarding the details of the electrode mixture layer and the laser light, reference can be made to the foregoing descriptions of the laser drying device. By irradiating the electrode mixture layer with laser light, the dispersion medium contained in the electrode mixture layer volatilizes, whereby an electrode active material layer is formed.

The dispersion medium contained in the electrode mixture layer is not particularly limited, and may be, for example, a non-polar solvent such as heptane, xylene, or toluene, or a polar solvent such as water, a tertiary amine solvent, an ether solvent, a thiol solvent, a ketone solvent (for example, diisobutyl ketone), or an ester solvent (for example, butyl butyrate).

The content of the dispersion medium is not particularly limited, and may be, for example, a quantity such that the solid content of the electrode mixture layer is 30% or more, 35% or more, 40% or more, 45% or more, or 50% or more, and may be a quantity such that the solid content of the electrode mixture layer is 80% or less, 75% or less, 70% or less, 65% or less, or 60% or less.

The method for applying the electrode mixture layer is not particularly limited, and a doctor blade method, a die coating method, a gravure coating method, a spray coating method, an electrostatic coating method, a bar coating method, etc., may be adopted.

The irradiation time of the laser light is not particularly limited, and for example, irradiation may be performed until the decreasing rate drying period of the electrode mixture layer is reached. The irradiation time of the laser light may be, for example, 30 seconds or more, 1 minute or more, or 2 minutes or more, and may be 30 minutes or less, 20 minutes or less, or 10 minutes or less.

The method of the present disclosure comprises supplying hot air to the interior of the furnace body. Regarding the details of the furnace body and supplying hot air, reference can be made to the foregoing descriptions of the laser drying device.

### <Electrode Laminate>

The electrode laminate may comprise an electrode active material layer and a current collector layer. The electrode active material layer may be a positive electrode active material layer or a negative electrode active material layer. The electrode laminate may also be a bipolar electrode laminate having a positive electrode active material layer and a negative electrode active material layer.

### (Electrode Active Material Layer)

When the electrode active material layer of the present disclosure is a positive electrode active material layer, the positive electrode active material layer contains at least a positive electrode active material. When the electrode active material layer is a negative electrode active material layer, the negative electrode active material layer contains at least a negative electrode active material. The electrode active material layer may further contain, as desired, a binder, a solid electrolyte, a conductive additive, etc. The electrode active material layer may also contain various other additives. The contents of the positive electrode active material, the negative electrode active material, the binder, the solid electrolyte, the conductive additive, etc., in the electrode active material layer may be appropriately determined in accordance with the desired battery performance.

The material of the positive electrode active material is not particularly limited as long as it is capable of absorbing and releasing lithium ions. Examples of the positive electrode active material include, but are not limited to, lithium cobalt oxide (LiCoO₂), lithium nickel oxide (LiNiO₂), lithium manganese oxide (LiMn₂O₄), lithium iron phosphate (LFP), lithium manganese iron phosphate (LMFP), nickel-cobalt-manganese lithium oxide (NCM:LiCO_{1/3}Ni_{1/3}Mn_{1/3}O₂), nickel-cobalt-aluminum lithium oxide (LiNi_{0.8}(CoAl)_{0.2}O₂), and heteroelement-substituted Li—Mn spinels having a composition represented by Li₁₊ₓMn_{2-x-y}M_{y}O₄ (where M is one or more metal elements selected from Al, Mg, Co, Fe, Ni, and Zn).

The form of the positive electrode active material is not particularly limited as long as it is a form which is generally adopted for the positive electrode active material of batteries. The positive electrode active material may be, for example, particulate. The positive electrode active material may be primary particles or secondary particles formed by aggregation of a plurality of primary particles. The average particle diameter D50 of the positive electrode active material may be, for example, 1 nm or more, 5 nm or more, or 10 nm or more, and may be 500 μm or less, 100 μm or less, 50 μm or less, or 30 μm or less. The average particle diameter D50 is the particle diameter (median diameter) at 50% of the integrated value in the volume-based particle size distribution determined by a laser diffraction/scattering method.

As the negative electrode active material, various materials which have a potential (charge/discharge potential) for absorbing and releasing lithium ions that is lower than that of the positive electrode active material of the present disclosure can be used. The material of the negative electrode active material is not particularly limited, and may be metallic lithium or a material which is capable of absorbing and releasing metal ions such as lithium ions. Examples of materials which are capable of absorbing and releasing metal ions such as lithium ions include, but are not limited to, alloy-based negative electrode active materials, carbon materials, and lithium titanate (Li₄Ti₅O₁₂).

The alloy-based negative electrode active material is not particularly limited, and examples thereof include Si alloy-based negative electrode active materials and Sn alloy-based negative electrode active materials. Examples of Si alloy-based negative electrode active materials include silicon, silicon oxide, silicon carbide, silicon nitride, and solid solutions thereof. The Si alloy-based negative electrode active material can contain metal elements other than silicon, such as Fe, Co, Sb, Bi, Pb, Ni, Cu, Zn, Ge, In, Sn, Ti, etc. Examples of Sn alloy-based negative electrode active materials include tin, tin oxide, tin nitride, and solid solutions thereof. The Sn alloy-based negative electrode active material can contain metal elements other than tin, such as Fe, Co, Sb, Bi, Pb, Ni, Cu, Zn, Ge, In, Ti, Si, etc.

The carbon material is not particularly limited, and examples thereof include hard carbon, soft carbon, graphite, etc.

The form of the negative electrode active material is not particularly limited as long as it is a form which is generally adopted for the negative electrode active material of batteries. The negative electrode active material may be, for example, in the form of particles or a sheet.

The material of the binder is not particularly limited. The binder may be, for example, polyvinylidene fluoride (PVdF), butadiene rubber (BR), polytetrafluoroethylene (PTFE), styrene butadiene rubber (SBR), etc., but is not limited thereto. The binder is not particularly limited, and one type may be used alone, or two or more types may be used in combination.

The material of the solid electrolyte is not particularly limited, and may be, for example, a sulfide solid electrolyte, an oxide solid electrolyte, or a polymer electrolyte.

Examples of sulfide solid electrolytes include, but are not limited to, sulfide-based amorphous solid electrolytes, sulfide-based crystalline solid electrolytes, and argyrodite-type solid electrolytes. Specific examples of sulfide solid electrolytes include Li₂S—P₂S₅-based electrolytes (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, etc.), LiI—Li₂S—P₂O₅, LiI—Li₃PO₄—P₂S₅, Li₇₋ₓPS₆₋ₓClₓ, etc.; or combinations thereof.

Examples of oxide solid electrolytes include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x} TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ (LiPON), etc.; or combinations thereof.

The sulfide solid electrolyte and the oxide solid electrolyte may be glass or crystallized glass (glass ceramics).

Examples of polymer electrolytes include, but are not limited to, polyethylene oxide (PEO), polypropylene oxide (PPO), and copolymers thereof.

The conductive additive is not particularly limited. The conductive additive may be, for example, vapor-grown carbon fiber (VGCF), acetylene black (AB), Ketjen black (KB), carbon nanotubes (CNT), carbon nanofibers (CNF), etc., but is not limited thereto. The conductive additive may be, for example, particulate or fibrous, and the size thereof is not particularly limited. The conductive additive is not particularly limited, and one type may be used alone, or two or more types may be used in combination. (Current Collector Layer)

The material of the current collector layer is not particularly limited, and any conductor which is commonly used in battery electrodes can be appropriately used. Examples of materials for the conductor layer include, but are not limited to, Cu, Ni, Cr, Au, Pt, Ag, Al, Fe, Ti, Zn, Co, and stainless steel. The current collector layer may also be a metal foil or a substrate on which a metal described above is plated or vapor-deposited.

The form of the current collector layer is not particularly limited, and examples thereof include foil, plate, mesh, etc. Among these, foil is preferable.

The thickness of the current collector layer is not particularly limited, and may be 0.1 μm or more, or 1 μm or more, and may be 1 mm or less, or 100 μm or less.

### EXAMPLES

The present invention will be specifically described with reference to Examples and Comparative Examples, but the present invention is not limited thereto.

### <<Preparation of Laser Drying Device>>

Laser drying devices configured as shown in FIG. 1, in which the distance y between the rectifier plate and the electrode mixture layer was adjusted as shown in Table 1, were prepared as Examples 1 to 5. The distance x between the laser light source and the electrode mixture layer was 1,500 mm. A laser drying device identical to those of Examples 1 to 5 except that a rectifier plate was not installed, was also prepared as Comparative Example 1.

The rectifier plate was made of quartz glass, and the transmittance of the laser light emitted from a 20 kW laser light source at a wavelength of 970 nm was 99.8%. The transmittance of the laser light was measured by spectrophotometry using a UV-Vis-NIR spectrophotometer (SolidSpec-3700 DUV, manufactured by Shimadzu Corporation).

The area of the rectifier plate was 90% of the bottom area of the furnace body (length in the conveyance direction×length in the width direction), and the rectifier plate was arranged in a position such that the hot air supplied from the air supply nozzle would not leak out above the rectifier plate in the height direction.

The temperature of the hot air supplied from the hot air supply equipment is 120° C.

### <<Evaluation of Drying Efficiency of Electrode Mixture Layer>>

### <Preparation of Electrode Mixture Layer>

An electrode mixture layer was prepared by mixing lithium cobalt oxide (LiCoO₂) as the electrode active material and styrene-butadiene copolymer (SBR) as the binder weighed at a mass ratio of 97.5:2.5 with ion-exchanged water at a solid content of 55%. Note that the basis weight of the electrode mixture layer was 35 mg/cm².

### <Evaluation of Drying Time>

The electrode mixture layer described above was applied to an aluminum foil serving as a current collector layer at a thickness of 400 μm, and the layer was then introduced into the laser drying devices of Examples 1 to 5, and the area including the center of the electrode mixture layer was irradiated with laser light.

The temperature at the center of the electrode mixture layer was continuously measured with a radiation thermometer, and the point at which the center of the electrode mixture layer entered a decreasing rate of drying was defined as the drying time. The drying times for the laser drying devices of Examples 1 to 5 are shown in Table 1.

TABLE 1

| | Position of laser | | | |
|---|---|---|---|---|
| | light source | Position of rectifier plate | | Drying |
| | x | y | x/y | time (s) |
| Comp Ex 1 | 1500 | No rectifier plate | | 106 |
| Ex 1 | 1500 | 200 | 0.13 | 85 |
| Ex 2 | 1500 | 150 | 0.10 | 80 |
| Ex 3 | 1500 | 100 | 0.07 | 74 |
| Ex 4 | 1500 | 50 | 0.03 | 65 |
| Ex 5 | 1500 | 10 | 0.01 | 50 |

From Examples 1 to 5 and Comparative Example 1 of Table 1, it can be understood that by arranging a rectifier plate between the electrode mixture layer and the laser light source in the furnace body, hot air can more easily be supplied to the electrode mixture layer, reducing drying time.

Furthermore, from Examples 1 to 5 of Table 1, it can be understood that by reducing x/y, hot air can more easily be supplied to the electrode mixture layer, further reducing drying time.

### REFERENCE SIGNS LIST

100 laser drying device
110 furnace body
111 exterior base material
112 laser-transmitting protective plate
120 rectifier plate
130 laser light source
140 hot air supply equipment
141 hot air generator
142 air supply duct
143 air supply nozzle
150 conveying equipment
151 conveyor belt
152 conveyor roller
160 exhaust equipment
200 laser light
300 electrode mixture layer

1. A laser drying device for drying an electrode mixture layer, wherein
the laser drying device comprises a furnace body, a rectifier plate, a laser light source, and hot air supply equipment,
the rectifier plate is arranged in an interior of the furnace body, is arranged between the electrode mixture layer and the laser light source, and is configured so as to transmit laser light,
the laser light source irradiates the electrode mixture layer with laser light via the rectifier plate, and
the hot air supply equipment supplies hot air between the rectifier plate and the electrode mixture layer.

2. The device according to claim 1, wherein the furnace body comprises a laser-transmitting protective plate, and
the laser light source irradiates the electrode mixture layer with laser light via the protective plate and then the rectifier plate.

3. The device according to claim 1, wherein when a distance between the laser light source and the electrode mixture layer is defined as x and a distance between the rectifier plate and the electrode mixture layer is defined as y, the following relationship is satisfied:
$$x / y \leq 0.15 .$$

4. The device according to claim 1, wherein a laser light transmittance of the rectifier plate with respect to laser light emitted from the laser light source is 95.0% or more.

5. A method for the production of an electrode laminate using the device according to claim 1,
the method comprising the steps of:
irradiating an electrode mixture layer applied to a current collector layer with laser light, and supplying hot air to an interior of the furnace body.
